(19) United States
(12) Patent Application Publication
(10) Pub. No.: US 2018/0175580 A1
(43) Pub. Date: Jun. 21, 2018

(54) LASER AMPLIFICATION DEVICE

(71) Applicant: HANDONG GLOBAL UNIVERSITY FOUNDATION, Pohang-si (KR)

(72) Inventors: Taejun Yu, Pohang-si (KR); Jihoon Jeong, Pohang-si (KR); Jeongmoog Kim, Daejeon (KR); Seryeyohan Cho, Tongyeong-si (KR)

(73) Assignee: HANDONG GLOBAL UNIVERSITY FOUNDATION, Pohang-si (KR)

(21) Appl. No.: 15/568,792

(22) PCT Filed: Apr. 27, 2015
(86) PCT No.: PCT/KR2015/004143

§ 371 Date: Oct. 23, 2017

(30) Foreign Application Priority Data
Apr. 24, 2015 (KR) 10-2015-0057885

(51) Int. Cl. H01S 3/10; H01S 3/00; H01S 3/23; B23K 26/06; H01S 3/08

(52) U.S. Cl. CPC H01S 3/10; H01S 3/0085; H01S 3/2308; H01S 3/06; H01S 3/08054; H01S 3/08072; B23K 26/0643

(57) ABSTRACT

A laser amplifier capable of achieving a high output by offsetting distortion of an amplified laser beam. The laser amplifier includes: first and second amplification media which amplify a penetrating laser beam; a pre-compensation lens unit which pre-compensates for a laser beam irradiated to the first amplification medium so as to offset a thermal lensing effect generated in the first amplification medium and the second amplification medium; a first polarizing and penetrating mirror inclined to the laser beam irradiated to a front end of the first amplification medium and allowing a laser beam that vibrates in a specific direction to penetrate and reflecting a laser beam that vibrates in another direction; a polarization conversion plate provided at a rear side of the second amplification medium and changing a vibration direction of the laser beam penetrating the second amplification medium; and a first reflection mirror for reflecting a laser beam.

### TECHNICAL FIELD

The present invention relates to a laser amplifier, and more particularly, to a laser amplifier which is capable of achieving a high output by offsetting distortion of an amplified laser.

### BACKGROUND ART

Recently, research on a field utilizing a laser is actively conducted in various industries and research sites.

Particularly, the laser is recently actively developed in a life site, such as 3D printing, lighting, communication, and performance and a factory site, such as welding, cutting, and surface modification, including a research field, such as spectroscopy, nano-imaging, particle acceleration, and nuclear fusion.

In the meantime, a laser for industry faces a task in high performance of an output thereof, and currently, a method of improving an output of a laser by amplifying oscillated laser while making the oscillated laser pass through an amplification medium layer has been used.

FIG. 1 is a diagram schematically illustrating a structure of a currently used double-pass laser amplifier.

In a double-pass laser amplifier 10 illustrated in FIG. 1, a pair of rod-shaped laser amplification media 20 is disposed while being spaced apart from each other, a polarization reflection mirror 30 is provided at a front side of the pair of laser amplification media 20, a polarization conversion plate 50 is provided at a rear side of the pair of laser amplification media 20, and a reflection mirror 40 is provided at a rear side of the polarization conversion plate 50.

Further, a 90° quartz rotator 60 may be provided between the pair of laser amplification media 20.

Accordingly, only a laser vibrating in a specific direction penetrates while a laser oscillated at the outside passes through the polarization reflection mirror 30, and after a penetrating laser is amplified while passing through the pair of amplification media 20, the amplified laser is reflected through the reflection mirror 40 and the reflected laser is amplified again while passing through the pair of amplification media 20 again.

In this case, when the laser passes through the polarization conversion plate 50 while reciprocating before and after being reflected by the reflection mirror 40, a polarization direction of the laser may be converted.

Further, the laser, of which the polarization direction is converted while passing through the polarization conversion plate 50, is reflected while failing to pass through the polarization reflection mirror 30, and the reflected laser may be irradiated to a target through a separately provided re-reflection mirror 70 or may be irradiated to another device.

In the meantime, heat may be generated when the laser passes through the laser amplification media 20, and a thermal polarization distortion effect is generated due to heat, so that the polarization direction of the penetrating laser beam may be non-uniformly distorted and a beam flowing backward may be generated.

Accordingly, the 90° quartz rotator 60 may be provided between both laser amplification media so as to offset the distortion of the laser irradiated to both sides of the 90° quartz rotator 60.

However, when the shapes of the laser beams irradiated to both surfaces of the 90° quartz rotator 60 are the same as each other and are symmetric to each other, a distortion offsetting effect may be complete, but a size of the laser beam may be gradually and asymmetrically changed by a thermal lensing effect by heat within the laser amplification media 20, and in this case, as illustrated in FIG. 1, there is a problem in that a part of the laser, which is reflected from the reflection mirror 40 and penetrates the laser amplification media 20, may penetrate without being reflected from the polarization reflection mirror 30 and may reversely flow (Lr).

In the meantime, as illustrated in FIG. 2, a structure, in which a lens set 80 is disposed between laser amplification media 20, is presented, but in the structure, a focus f is formed inside a laser amplifier, so that spark may be generated at a portion, at which the focus f is formed and stability may deteriorate, and thus in order to achieve a high output, an additional configuration, such as a separate vacuum tube (not illustrated), for preventing the spark is required, and further, the laser may be reflected from a surface of the lens while passing through the lens, so that a burden in a design may be increased.

Further, as illustrated in FIG. 3, a structure, in which both surfaces of a laser amplification medium 22 are formed to be inclined or curved, is also presented. In the structure, there is no portion, in which a focus is formed, inside a laser amplifier, so that a vacuum tube is not required, and a lens group is not required or is minimized, so that the number of reflection surfaces may also be minimized.

However, both surfaces of the laser amplification medium 22 are inclined or curved, so that an aberration may be generated in a laser, and an optical system may be damaged due to a surface reflection of a laser by the concave optical surface, so that a burden in a design may also be increased.

### DISCLOSURE

### Technical Problem

The present invention has been made in an effort to solve the aforementioned problems, and an object of the present invention is to provide a laser amplifier which is capable of achieving a higher output by minimizing a distortion phenomenon and a back flow phenomenon of a laser beam through a maximally simple configuration.

Objects of the present invention are not limited to the objects mentioned above, and other objects that are not mentioned will be clearly understood by a person skilled in the art from the description below.

### Technical Solution

In order to solve the aforementioned problems, according to the exemplary embodiment of the present invention, there is provided a laser amplifier including: a first amplification medium which amplifies a penetrating laser; a second amplification medium which is disposed while being spaced apart from the first amplification medium and amplifies the penetrating laser; a pre-compensation lens unit which is provided at a front side of the first amplification medium, and pre-compensates for a laser irradiated to the first amplification medium so as to offset a thermal lensing effect generated in the first amplification medium and the second amplification medium; a first polarizing and penetrating mirror which is provided to be inclined to the laser irradiated to a front end of the first amplification medium, and allows a laser that vibrates in a specific direction in irradiated light to penetrate and reflects a laser that vibrates in another direction; a polarization conversion plate which is provided at a rear side of the second amplification medium and changes a vibration direction of the laser penetrating the second amplification medium; and a first reflection mirror which is provided at a rear side of the polarization conversion plate, and reflects a laser.

The first reflection mirror may be formed with a convex reflective surface so that the reflected laser is reflected in the same path as an irradiation path of the reflected laser.

The first reflection mirror may be formed with a convex reflective surface so that a predetermined point of a cross section of the laser irradiated to the reflective surface is vertical to the reflective surface.

The pre-compensation lens unit may diffuse the laser so that a beam diameter of the laser is increased when the laser reaches the first amplification medium by an amount corresponding to a beam diameter of the laser that is contracted until the laser passes through the first amplification medium and the second amplification medium and reaches the reflection mirror.

The pre-compensation lens unit may be provided in a combination of a convex lens and a concave lens.

The pre-compensation lens unit may be provided in a combination of convex lenses.

The laser amplifier may further include a quartz rotator which is provided between the first amplification medium and the second amplification medium and offsets distortion of the laser irradiated to both surfaces of the quartz rotator.

The laser amplifier may further include a second reflection mirror which re-reflects the laser reflected from the first polarizing and penetrating mirror.

### Advantageous Effects

The laser amplifier of the present invention has the effects described below.

First, the pre-compensation lens unit is provided and diffuses and compensates for the laser in advance by an amount of a beam width that is decreased while the laser passes through the first amplification medium and the second amplification medium, so that it is possible to pre-compensate for a lensing effect due to heat of the laser beam, thereby minimizing distortion and a reverse flow phenomenon of the laser beam.

Secondly, the reflection mirror is formed with a curved surface, not a plane surface, so that a predetermined point of a cross section of the laser irradiated to the reflection mirror is vertical to the reflective surface and thus the laser may be reflected in the same path as a path in which the laser is irradiated to the reflection mirror, so that the shapes and the diameters of the laser beam may be completely symmetric to each other on both surfaces of the 90° quartz rotator, thereby minimizing a reverse flow phenomenon of the laser beam and achieving a higher output of the laser.

The effects of the present invention are not limited to the aforementioned effects, and other effects, which are not mentioned above, will be clearly understood by those skilled in the art from the claims.

### DESCRIPTION OF DRAWINGS

Detailed descriptions of an exemplary embodiment of the present application described below and the foregoing summary may be more fully understood when the accompanying drawings are referred to. The exemplary embodiments are illustrated in the drawings for the purpose of illustrating the present invention. However, it should be understood that the present application is not limited to accurate dispositions and means illustrated in the drawings.

FIG. 1 is a diagram illustrating an example of a laser amplifier in the related art;

FIG. 2 is a diagram illustrating another example of a laser amplifier in the related art;

FIG. 3 is a diagram illustrating another example of a laser amplifier in the related art;

FIG. 4 is a diagram illustrating a laser amplifier according to an exemplary embodiment of the present invention;

FIG. 5 is a diagram illustrating a laser amplifier according to another exemplary embodiment of the present invention;

FIG. 6 is a graph illustrating a change in a radius of a beam according to a distance of a laser amplified by the laser amplifier of FIG. 1;

FIG. 7 is a graph illustrating a change in a radius of a beam according to a distance of a laser amplified by the laser amplifier of FIG. 4;

FIG. 8 is a graph of a comparison between focal distances of a laser amplified by the laser amplifier in the related art and the laser amplifier according to the exemplary embodiment of the present invention when an interval between amplification media is 10 cm;

FIG. 9 is a graph of a comparison between focal distances of a laser amplified by the laser amplifier in the related art and the laser amplifier according to the exemplary embodiment of the present invention when an interval between amplification media is 30 cm;

FIG. 10 is a diagram illustrating a simulation of shapes and rates of laser beams amplified and output by the laser amplifier in the related art and the laser amplifier according to the exemplary embodiment of the present invention, and shapes and rates of reversely flowing beams in the laser amplifier in the related art and the laser amplifier according to the exemplary embodiment of the present invention; and

FIG. 11 is a graph illustrating loss rates according to a change in an operation condition of the laser amplifier in the related art and the laser amplifier according to the exemplary embodiment of the present invention.

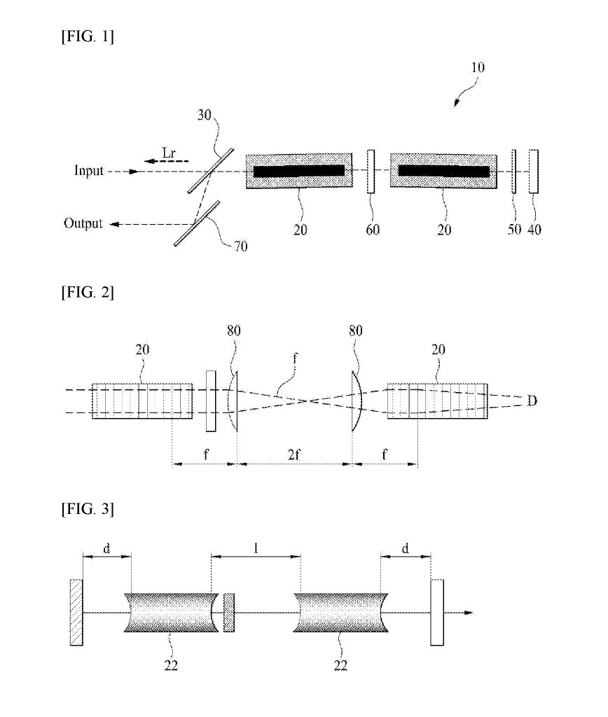

### BEST MODE

Hereinafter, an exemplary embodiment of the present invention, in which an object of the present invention may be particularly implemented, is described with reference to the accompanying drawings. In describing the present exemplary embodiment, the same name and the same reference numeral are used for the same configuration, and an additional description of the same configuration will be omitted.

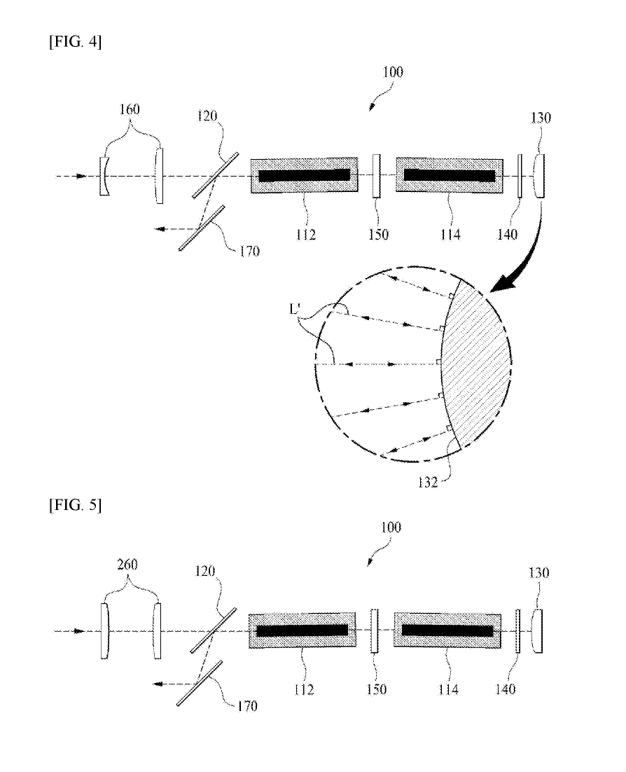

A laser amplifier according to the present exemplary embodiment may include a first amplification medium 112, a second amplification medium 114, a pre-compensation lens unit 160, a first polarizing and penetrating mirror 120, a polarization conversion plate 140, a first reflection mirror 130, a quartz rotator 150, and a second reflection mirror 170 as illustrated in FIG. 4.

In the meantime, the laser amplifier 100 of the present exemplary embodiment, which is a device for amplifying an irradiated laser, may separately include a laser oscillator (not illustrated) that irradiates a laser to the laser amplifier 100.

The first polarizing and permeating mirror 120 may be provided so as to allow a polarized laser that vibrates in a specific direction in the irradiated laser to penetrate and allow a polarized laser that vibrates in another direction to be reflected.

The present exemplary embodiment will be described based on an example in which the first polarizing and penetrating mirror 120 allows a P-polarized laser to penetrate and reflects a polarized laser in another direction.

Further, the first polarizing and penetrating mirror 120 may be formed to have an inclination with an irradiation angle of a laser.

In the meantime, a laser oscillated by the laser oscillator (not illustrated) may be a P-polarized laser. The present invention is not limited to the kind of penetrating and polarized light of the first polarizing and penetrating mirror 120 and the kind of polarization of the laser oscillated by the laser oscillator (not illustrated) as a matter of course.

Further, the first amplification medium 112 and the second amplification medium 114 may be provided at a rear side of the first polarizing and penetrating mirror 120, may be Nd:YAG rods which amplify a penetrating laser, the laser passing through the first polarizing and penetrating mirror 120, and may be provided while being spaced apart from each other in a laser irradiation path.

The polarization conversion plate 140 is a constituent element which is provided at a rear side of the second amplification medium 114 and converts a vibration direction of the penetrating laser, and may be a λ/4 plate.

Further, the first reflection mirror 130 is a constituent element which is provided at a rear side of the polarization conversion plate 140 and reflects the irradiated laser toward the first amplification medium 112 and the second amplification medium 114 again, and may be formed so that a reflective surface 132, from which the laser is reflected, has a convex shape.

Further, the 90° quartz rotator 150 may be provided between the first amplification medium 112 and the second amplification medium 114.

The 90° quartz rotator 150 is a constituent element which offsets polarization and distortion due to heat generated in the first amplification medium 112 and the second amplification medium 114 positioned at both sides of the 90° quartz rotator 150 in order to prevent a reversely flowing beam.

Accordingly, only the laser of a component (p-polarization) vibrating in a specification direction may penetrate while the laser oscillated by the laser oscillator (not illustrated) penetrates the first polarizing and penetrating mirror 120.

The laser penetrating the first polarizing and penetrating mirror 120 may be amplified while penetrating the first amplification medium 112 and the second amplification medium 114.

Further, the amplified laser may be reflected from the first reflection mirror 130 and amplified while passing through the first amplification medium 112 and the second amplification medium 114 again.

In this case, the laser may pass through the polarization conversion plate 140 provided between the first reflection mirror 130 and the second amplification medium 114, and a polarization direction of the laser may be changed into another direction while the laser passes through the polarization conversion plate 140 two times.

In the meantime, the laser reflected from the first reflection mirror 130 and penetrating the second amplification medium 114 and the first amplification medium 112 meets the first polarizing and penetrating mirror 120, and in this case, the laser is in the state where the polarization direction is changed while passing through the polarization conversion plate 140, so that the laser may be reflected while failing to penetrate the first polarizing and penetrating mirror 120.

Further, the second reflection mirror 170 which reflects the reflected laser to a required position again may be provided.

In the meantime, when the laser passes through first amplification medium 112 and the second amplification medium 114, the first amplification medium 112 and the second amplification medium 114 may be heated, and a thermal lensing effect may be generated by the heated first amplification medium 112 and second amplification medium 114.

Accordingly, the laser is gradually focused by the thermal lensing effect while passing through the first amplification medium 112 and the second amplification medium 114, so that a beam diameter of the laser may be decreased.

Accordingly, in the present exemplary embodiment, the pre-compensation lens unit 160 may be provided at a front side of the first polarizing and penetrating mirror 120 to diffuse the laser beam so that the beam diameter of the laser is expanded by an amount corresponding to the beam diameter that is decreased by the thermal lensing effect of the first amplification medium 112 and the second amplification medium 114.

The pre-compensation lens unit 160 may have a Galileo form including a convex lens and a concave lens, and may be provided between the first polarizing and penetrating mirror 120 and the laser oscillator (not illustrated).

The present invention is not limited thereto as a matter of course, and as illustrated in FIG. 5, the pre-compensation lens unit 160 may also have a Kepler form formed with a combination of convex lenses.

Accordingly, the pre-compensation lens unit 160 may allow the laser to be incident into the first amplification medium 112 in a state where the laser is diffused so that a diameter of the laser when the laser is first incident into the first amplification medium 112 is expanded by an amount corresponding to a beam diameter of the laser that is decreased when the laser is focused while reciprocating and passing through the first amplification medium 112 and the second amplification medium 114.

In this case, the amount of beam diameter decreased when the laser is focused while passing through the first amplification medium 112 and the second amplification medium 114 may be varied according to an output of the laser, so that the pre-compensation lens unit 160 may be provided so that a distance between each convex lens and each concave lens is adjustable so as to adjust the amount of laser beam diffused.

In the meantime, even though the pre-compensation lens unit 160 is provided, the laser may be focused while passing through the first amplification medium 112 and the second amplification medium 114 to be focused in a direction in which the beam diameter is decreased after passing through the second amplification medium 114.

In this case, the first reflection mirror 130 is formed to be convex so that a predetermined point of a cross section of a laser beam L′ irradiated to the reflective surface 132 of the first reflection mirror 130 is vertical to the reflective surface 132, so that the laser L′ reflected from the reflective surface 132 of the first reflection mirror 130 may be reflected while having the same path as a path in which the laser beam L′ is irradiated to the reflective surface.

That is, the laser beam L′ focused in the direction in which the beam diameter is decreased may be reflected from the convex reflective surface 132 of the first reflection mirror 130 to be reflected in a direction in which the laser beam is diffused while having the same angle and the same path as the angle and the path in which the laser beam L′ is irradiated to the reflective surface 132.

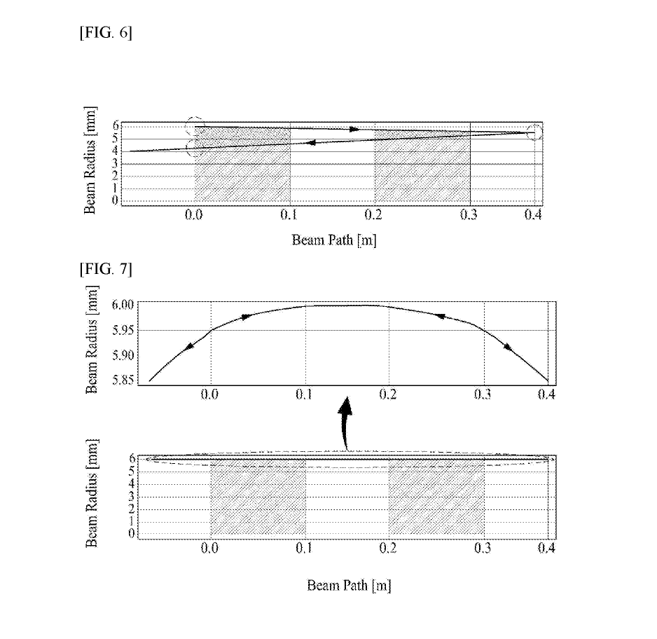

FIG. 6 is a graph illustrating a change in a diameter of a laser beam amplified by the laser amplifier in the related art.

The laser amplifier is installed so that a length of the amplification medium 20 is about 10 cm, and an interval between the amplification media 20 is about 10 cm.

As illustrated in FIG. 6, a laser beam first incident into the amplification medium 20 has a radius of 6 mm, and the diameter of the laser beam is decreased by the thermal lensing effect while passing through each amplification medium 20, so that the radius of the laser beam may be decreased to a radius of about 4.4 mm after the laser beam is reflected from the reflection mirror 40 and then penetrates all of the amplification media 20.

FIG. 7 is a graph illustrating a change in a diameter of a laser beam amplified by the laser amplifier 100 of the present exemplary embodiment.

Similar to the related art, the laser amplifier is installed so that the first amplification medium 112 and the second amplification medium 114 have lengths of about 10 cm, and an interval between the first amplification medium 112 and the second amplification medium 114 is about 10 cm.

As illustrated in FIG. 7, a laser irradiated to the laser amplifier 100 according to the present exemplary embodiment may be diffused by the pre-compensation lens unit 160 so that a beam diameter of the laser is increased to about 5.95 mm when the laser is incident into the first amplification medium 112, may be focused while passing through the first amplification medium 112 and the second amplification medium 114, then, may be reflected from the first reflection mirror 130 and may be diffused again, and may be focused again while passing through the first amplification medium 112 and the second amplification medium 114.

In this case, it can be seen that the change in the diameter of the laser beam from the first irradiation of the laser to the reaching of the laser to the first reflection mirror 130 while passing through the first amplification medium 112 and the second amplification medium 114 is the same as the change in the diameter of the laser beam which passes through the first amplification medium 112 and the second amplification medium 114 after being reflected from the first reflection mirror 130.

In FIG. 7, the amount of change in the diameter of the laser beam is excessively small and is not meaningfully present in the graph, so that a scale of a corresponding part is separately expanded and illustrated.

Accordingly, the changes of the diameters of the laser beams at both sides based on the quartz rotator 150 are the same and the diameters of the laser beams reaching both lateral surfaces of the quartz rotator 150 are the same, so that the distorted laser beam penetrating the quartz rotator 150 may be removed.

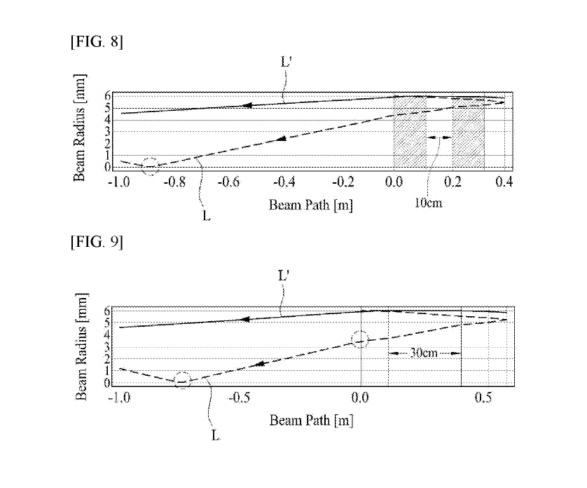

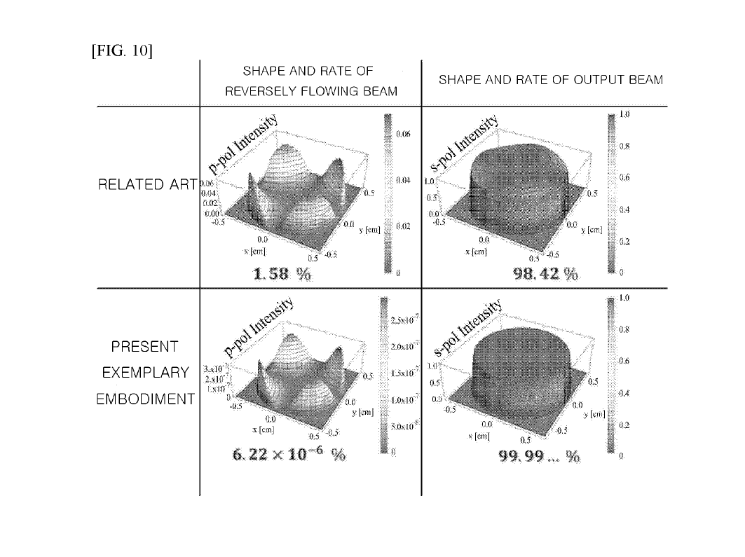

FIGS. 8 and 9 are graphs illustrating the changes of the diameters of the laser beams amplified by the laser amplifier in the related art and the laser amplifier of the present exemplary embodiment according to a change in an interval between the first amplification medium 112 and the second amplification medium 114.

FIG. 8 illustrates the case where an interval between the first amplification medium 112 and the second amplification medium 114 is about 10 cm, and FIG. 8 illustrates the case where an interval between the first amplification medium 112 and the second amplification medium 114 is about 30 cm.

As illustrated in FIG. 8, it can be seen that when an interval between the first amplification medium 112 and the second amplification medium 114 is about 10 cm, a laser L amplified by the laser amplifier 10 in the related art progresses about 89 cm after finally passing through the first amplification medium 112 and is focused.

In contrast to this, it can be seen that the laser L′ amplified by the laser amplifier 100 of the present exemplary embodiment progresses about 4.3 m after finally passing through the first amplification medium 112 and is focused.

In the graph, a difference in the point, at which the laser is focused, between the related art and the present exemplary embodiment is too big, so that the point, at which the laser L′ amplified by the laser amplifier 100 of the present exemplary embodiment is focused, is not indicated, and when a diameter of the laser beam is decreased with an inclination illustrated in the graph, it can be seen that a point, at which the diameter of the laser beam L′ is minimized, is about 4.3 m.

That is, it can be seen that the laser L′ amplified by the laser amplifier 100 of the present exemplary embodiment is focused in the far distance than the distance in which the laser L amplified by the laser amplifier 10 in the related art is focused, which may exert an effect in which it is possible to have a larger spatial room in designing a post-processing device which further treats the amplified laser.

When the focal distance of the amplified laser is too small like the related art, a space, in which a post-processing device that treats later the amplified laser is to be positioned, may be too narrow, and in order to solve the problem, a configuration, such as a lens, diffusing the amplified laser again is required, and the configuration, such as the lens, may reflect the laser, and considering the state where the laser is amplified, peripheral equipment or lens may be burned.

Further, as illustrated in FIG. 9, investigating the case where an interval between the first amplification medium 112 and the second amplification medium 114 is about 30 cm, it can be seen that the laser L amplified by the laser amplifier 10 in the related art progresses about 75 cm after finally passing through the first amplification medium 112 and is focused. It can be seen that the focal distance is further decreased than the focal distance when the interval between the first amplification medium 112 and the second amplification medium 114 is 10 cm.

In addition, it can be seen that a radius of the laser beam L emitted from the first amplification medium 112 is also 3.4 mm and is further decreased compared to the radius of the laser beam L when the interval between the first amplification medium 112 and the second amplification medium 114 is about 10 cm, and when the radius of the laser beam L is decreased, a density of energy is increased, so that there is also danger in damaging the amplification medium.

In contrast to this, the laser L′ amplified by the laser amplifier 100 of the present exemplary embodiment progresses about 4.3 m after finally passing through the first amplification medium 112 and is focused, and therefore, it can be seen that a diameter of the laser beam L′ amplified by the laser amplifier 100 of the present exemplary embodiment is irrelevant to the interval between the first amplification medium 112 and the second amplification medium 114.

Accordingly, according to the laser amplifier 100 of the present exemplary embodiment, it is possible to freely design the interval between the first amplification medium 112 and the second amplification medium 114, thereby achieving an effect in sufficiently securing a space required for repairing and maintaining various constituent elements provided between the first amplification medium 112 and the second amplification medium 114.

FIG. 10 is a diagram illustrating a simulation of shapes and rates of laser beams amplified and output by the laser amplifier in the related art and the laser amplifier according to the exemplary embodiment of the present invention, and shapes and rates of reversely flowing beams in the laser amplifier in the related art and the laser amplifier according to the exemplary embodiment of the present invention.

The reversely flowing laser beams among the laser beams amplified in the laser amplifier in the related art are 1.58% of the total output laser beams, and the normally output laser beams are present to be 98.42%.

In contrast to this, the reversely flowing laser beams among the laser beams amplified in the laser amplifier of the present exemplary embodiment are 6.22*10⁻⁶% of the total output laser beams, and it can be seen that the reversely flowing laser beams are noticeably decreased compared to the reversely flowing laser beams in the related art. Accordingly, the normally output laser beams are also 99.99% or more, so that it can be seen that almost the whole output beams are normally output, and it can be seen that the shapes of the output beams are nearer to perfect than the shapes of the output beams in the related art.

Accordingly, even though the laser beam is more intensively amplified, there have little reversely flowing beam, so that there are effects in improving output efficiency and minimizing danger in damaging equipment.

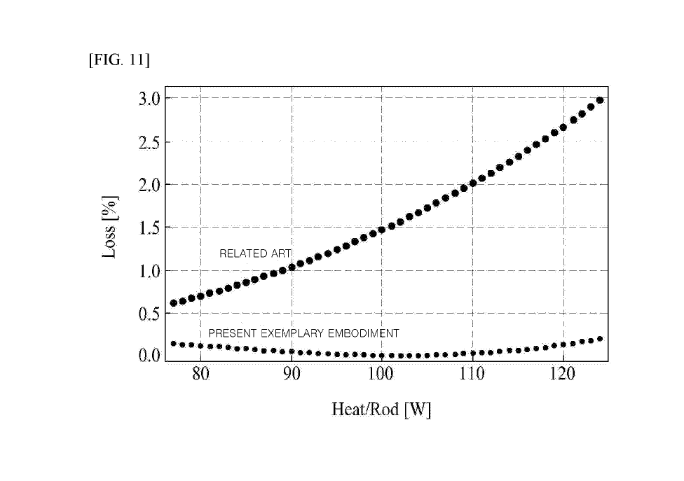

FIG. 11 is a graph illustrating loss rates according to a change in an operation condition of the laser amplifier in the related art and the laser amplifier according to the exemplary embodiment of the present invention.

An operation condition in the graph may be a rate of the amount of amplification of the amplification medium and the amount of heat generated of the amplification medium, and a loss rate may be a ratio of reversely flowing beams.

As can be seen in the graph of FIG. 11, in the laser amplifier in the related art, a loss rate is sharply increased when the amount of heat generated of the amplification medium is increased, but in the laser amplifier of the present exemplary embodiment, even though the amount of heat generated is increased, a loss rate is stably maintained regardless of the amount of heat generated.

The exemplary embodiments according to the present invention have been described above, and it is obvious to those skilled in the art that in addition to the aforementioned exemplary embodiments, the present invention may be implemented as other specific forms without departing from the purpose and the scope of the present invention. Accordingly, the aforementioned exemplary embodiments should be only illustrative and not restrictive for this invention, and thus, the present invention is not limited to the aforementioned description, but may be modified within the scope of the appended claims and equivalents thereto.

1. A laser amplifier, comprising:
a first amplification medium which amplifies a penetrating laser;
a second amplification medium which is disposed while being spaced apart from the first amplification medium and amplifies the penetrating laser;
a pre-compensation lens unit which is provided at a front side of the first amplification medium, and pre-compensates for a laser irradiated to the first amplification medium so as to offset a thermal lensing effect generated in the first amplification medium and the second amplification medium;
a first polarizing and penetrating mirror which is provided to be inclined to a laser irradiated to a front end of the first amplification medium, and allows a laser that vibrates in a specific direction in irradiated light to penetrate and reflects a laser that vibrates in another direction;
a polarization conversion plate which is provided at a rear side of the second amplification medium and changes a vibration direction of the penetrating laser; and
a first reflection mirror which is provided at a rear side of the polarization conversion plate, and reflects a laser.

2. The laser amplifier of claim 1, wherein the first reflection mirror is formed with a convex reflective surface so that the reflected laser is reflected in the same path as a path in which the reflected laser is irradiated.

3. The laser amplifier of claim 2, wherein the first reflection mirror is formed with a convex reflective surface so that a predetermined point of a cross section of the laser irradiated to the reflective surface is vertical to the reflective surface.

4. The laser amplifier of claim 1, wherein the pre-compensation lens unit diffuses the laser so that a beam diameter of the laser is increased when the laser reaches the first amplification medium by an amount corresponding to a beam diameter of the laser that is contracted until the laser passes through the first amplification medium and the second amplification medium and reaches the reflection mirror.

5. The laser amplifier of claim 4, wherein the pre-compensation lens unit is provided in a combination of a convex lens and a concave lens.

6. The laser amplifier of claim 4, wherein the pre-compensation lens unit is provided in a combination of convex lenses.

7. The laser amplifier of claim 1, further comprising:
a quartz rotator which is provided between the first amplification medium and the second amplification medium and offsets distortion of the laser irradiated to both surfaces of the quartz rotator.

8. The laser amplifier of claim 1, further comprising:
a second reflection mirror which re-reflects the laser reflected from the first polarizing and penetrating mirror.
